(19) United States
(12) Patent Application Publication
(10) Pub. No.: US 2018/0099313 A1
(43) Pub. Date: Apr. 12, 2018

(54) Filtering Screen

(71) Applicant: CHIA YI STEEL CO., LTD., Chiayi Hsien (TW)

(72) Inventors: Chien-Hung Yeh, Chiayi Hsien (TW); Cheng-Chin Wang, Chiayi Hsien (TW)

(21) Appl. No.: 15/286,709

(22) Filed: Oct. 6, 2016

(51) Int. Cl. B07B 1/46

(52) U.S. Cl. CPC B07B 1/469; B07B 1/4636; B07B 1/4618

(57) ABSTRACT

A filtering screen has a plate. The plate has a top surface, a bottom surface, and at least one screening area. The at least one screening area is defined in the plate and has multiple screening holes defined through the top surface and the bottom surface. Each screening hole has an upper segment and a lower segment connected and communicating with the upper segment. The upper segment of each screening hole has a unique diameter. The lower segment of each screening hole is conical and has a diameter gradually decreasing from a top end of the lower segment to a bottom end of the lower segment.

### BACKGROUND OF THE INVENTION

### 1. Field of the Invention

The present invention relates to a filtering screen, and more particularly to a filtering screen that is applied to screen powders or granules.

### 2. Description of Related Art

To screen powders or granules, a filtering screen is provided. With reference to FIG. 5, a conventional filtering screen comprises a frame 30 and a screen net 31 mounted in the frame 30. The screen net 31 is composed of multiple strings woven in a criss-cross manner to define multiple square screening holes arranged in a matrix. The dimensions of each screening hole are determined depending on the sizes of the powders or granules to be screened.

To screen powders or granules, the objects to be screened are put on the screen net 31 and the filtering screen is vibrated. With the vibration of the filtering screen, the objects in a diameter smaller than the dimensions of the screening holes can pass through the screening holes, and the objects in a diameter larger than the dimensions of the screening holes will be kept on the filtering screen.

However, because the screen net 31 is composed of multiple woven strings, the strength of the screen net is insufficient. With reference to FIG. 6, the screening holes are easily deformed, and the dimensions of the deformed screening holes are changed. Accordingly, an enlarged screening hole may allow an object that has a diameter larger than the predetermined dimensions to pass through the deformed screening hole. An object having the predetermined dimensions is not allowed to pass through a dimension-reduced screening hole. Consequently, the accuracy of using the filtering screen is reduced.

To overcome the shortcomings, the present invention tends to provide a filtering screen to mitigate or obviate the aforementioned problems.

### SUMMARY OF THE INVENTION

The main objective of the invention is to provide a filtering screen that has a sufficient structural strength and is not easily deformed.

The filtering screen has a plate. The plate has a top surface, a bottom surface, and at least one screening area. The at least one screening area is defined in the plate and has multiple screening holes defined through the top surface and the bottom surface. Each screening hole has an upper segment and a lower segment connected and communicating with the upper segment. The upper segment of each screening hole has a unique diameter. The lower segment of each screening hole is conical and has a diameter gradually decreasing from a top end of the lower segment to a bottom end of the lower segment.

Other objects, advantages and novel features of the invention will become more apparent from the following detailed description when taken in conjunction with the accompanying drawings.

### BRIEF DESCRIPTION OF THE DRAWINGS

FIG. 1 is a front view of a filtering screen in accordance with the present invention;

FIG. 2 is an enlarged cross sectional side view of the filtering screen in FIG. 1;

FIG. 3 shows operational cross sectional side views of a process for forming the filtering screen in FIG. 1;

FIG. 4 is an enlarged operational cross sectional side view of the filtering screen in FIG. 1;

FIG. 5 is a front view of a conventional filtering screen; and

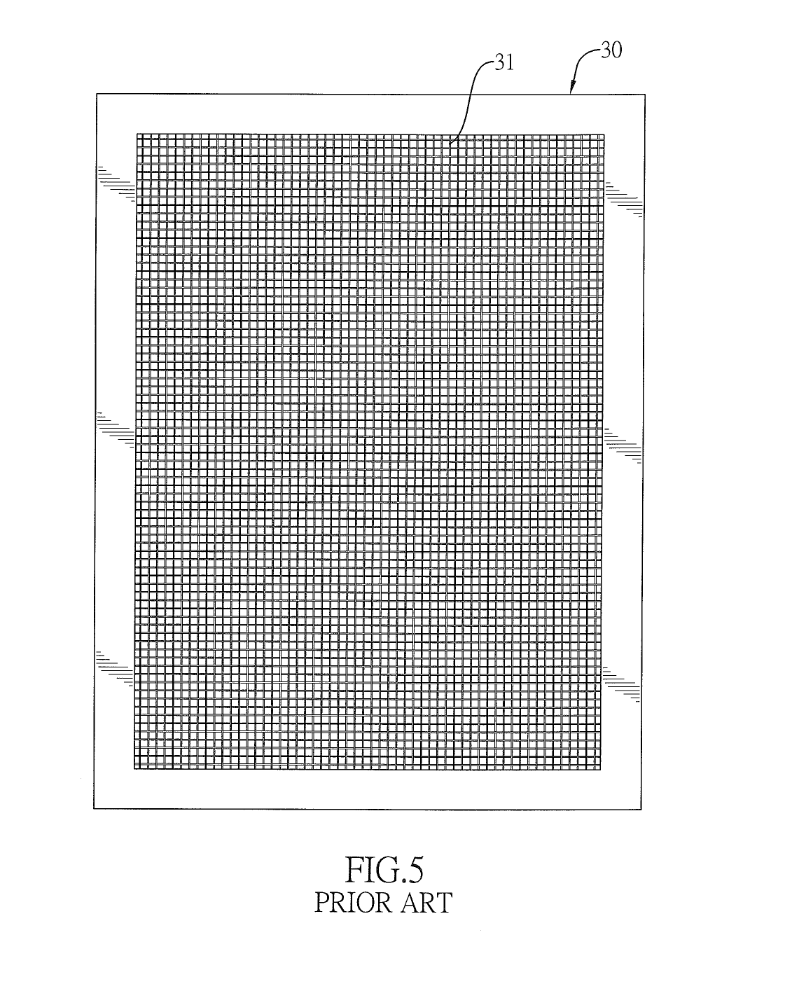

FIG. 6 is an enlarged front view of a deformed filtering screen in FIG. 5.

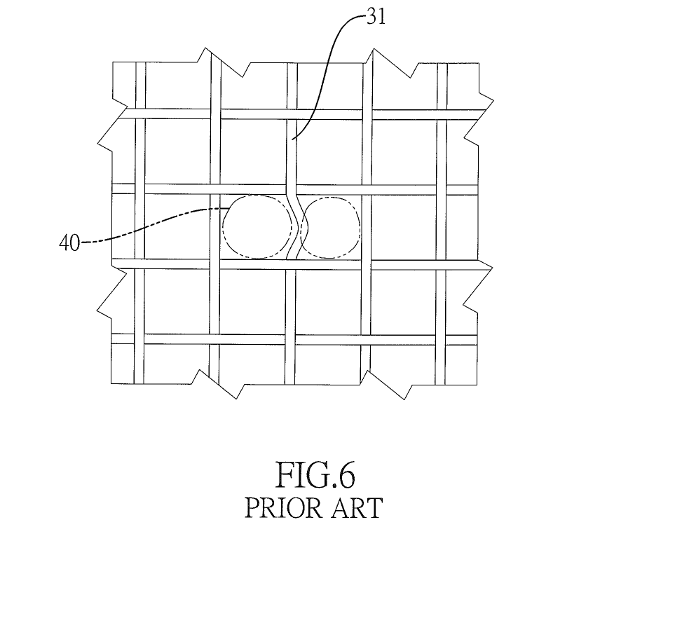

### DETAILED DESCRIPTION OF PREFERRED EMBODIMENT

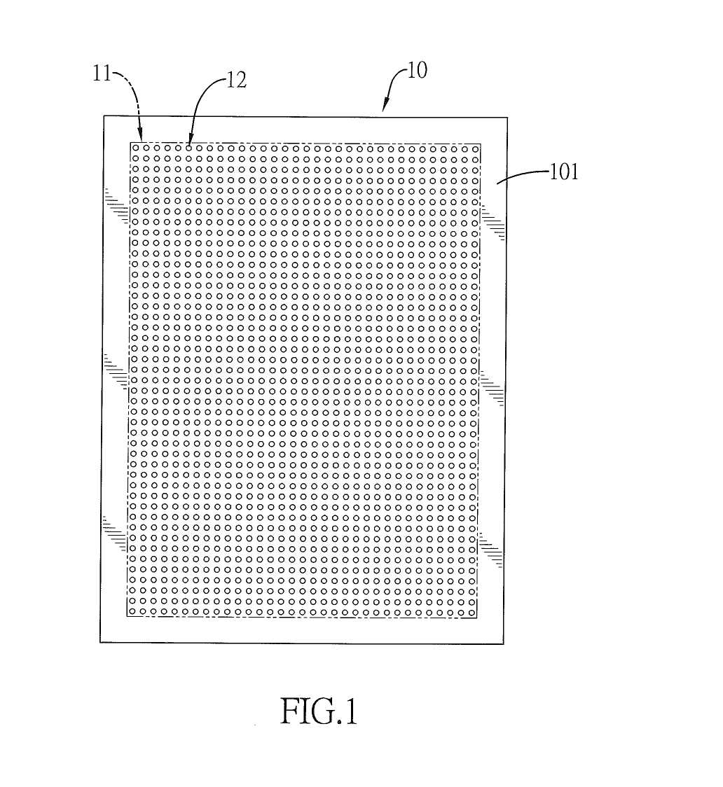

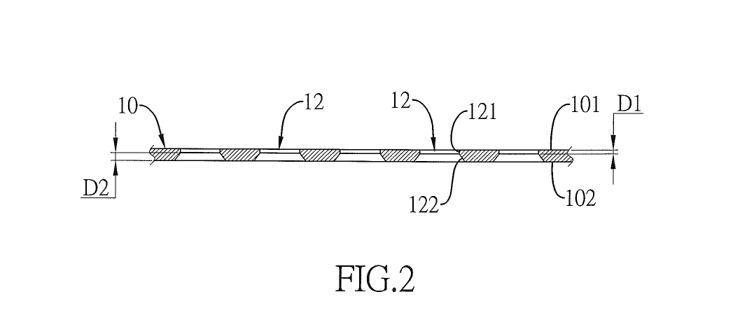

With reference to FIGS. 1 and 2, a filtering screen in accordance with the present invention comprises a plate 10. The plate 10 has a top surface 101, a bottom surface 102, and at least one screening area 11. The at least one screening area 11 is defined in the plate 10, and the number of the screening area 11 can be changed based on usage demand. Each screening area 11 comprises multiple screening holes 12 defined through the top surface 101 and the bottom surface 102.

The screening holes 12 may be formed in the plate 10 by etching processes. Each screening hole 12 has an upper segment 121 and a lower segment 122 connected and communicating with the upper segment 121. The upper segment 121 of the screening hole 12 is defined in the top surface 101 of the plate 10 and has a bottom end, and the lower segment 122 of the screening hole 12 is connected and communicates with the bottom end of the upper segment 121 and has a bottom end extending to the bottom surface 102 of the plate 10. The upper segment 121 of each screening hole 12 has its unique predetermined dimensions for screening an object in a predetermined diameter. The lower segment 122 is conical and has a diameter gradually decreasing from a top end of the lower segment 122 to the bottom end of the lower segment 122. The diameter of the top end of the lower segment 122 is same as that of the bottom end of the upper segment 121. Preferably, the upper segment 121 of each screening hole 12 has a circular cross section, and the lower segment 122 of each screening hole 12 has a circular cross section. In addition, the upper segment 121 of each screening hole 12 has a depth D1 smaller than or equal to a depth D2 of the lower segment 122 of the screening hole 12.

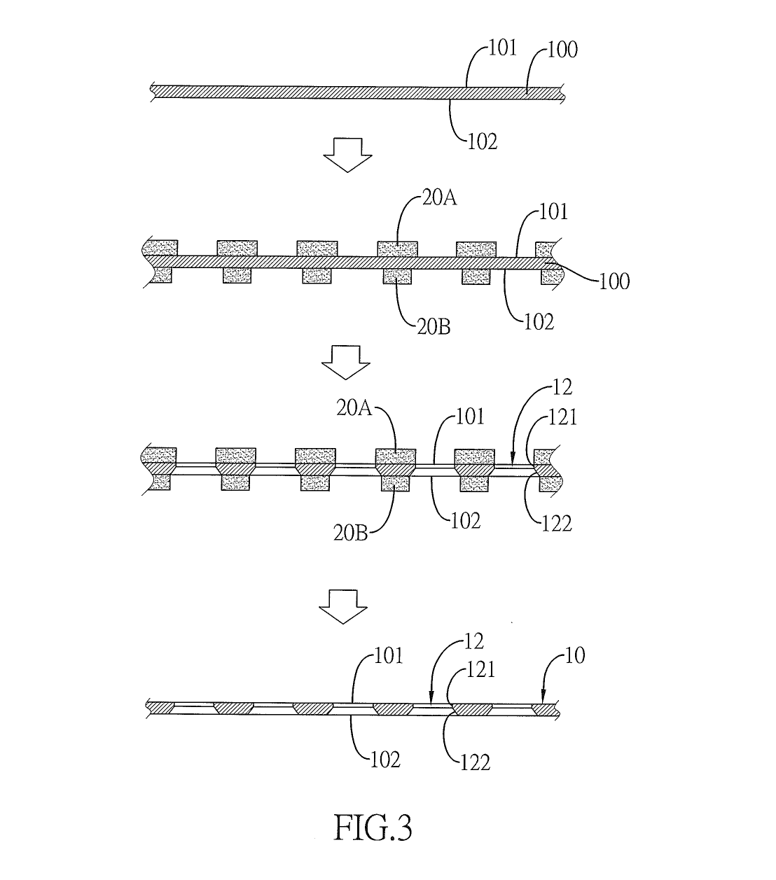

With reference to FIG. 3, to form a filtering screen in accordance with the present invention, a metal flat plate 100 is provided and is formed with a first photoresist layer 20A on the top surface 101 of the metal flat plate 100. A second photoresist layer 20B is formed on the bottom surface 102 of the metal flat plate 100. With a physical or chemical etching process, multiple upper segments 121 in unique dimensions are formed in the top surface 101 of the metal flat plate 100 based on the shape of the first photoresist layer 20A, and multiple conical lower segments 122 are formed in the bottom surface 102 of the metal flat plate 100 based on the shape of the second photoresist layer 20B and communicate respectively with the upper segments 121. Accordingly, the multiple screening holes 12 are formed.

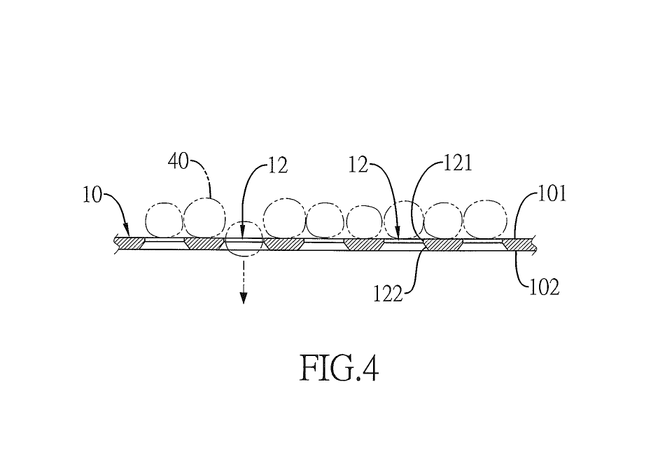

With reference to FIG. 4, in use, objects to be screened are put on the top surface 101 of the plate 10, and the plate 10 is vibrated. With the vibration of the plate 10, the objects having diameters smaller than the dimensions of the upper segments 121 of the screening holes 12 can pass through the screening holes 12. Because the lower segments 122 of the screening holes 12 are conical, the passing objects will not be blocked by the conical lower segments 122 of the screening holes 12. Thus, the passing objects will not be stuck in the screening holes 12. The objects having diameters larger than the dimensions of the upper segments 121 of the screening holes 12 remain on the top surface 101 of the plate 10.

With the arrangement of the unique diameter of the upper segments 121 and the conical lower segments 122, the screening holes 12 have a sufficient structural strength. Thus, the thickness of the plate 10 can be effective reduced, and the passing travel distance for screening objects can be also shortened.

In addition, the shapes of the screening holes 12 can be well controlled by the etching processes. The distance between adjacent two screening holes 12 is sufficient. The screening holes 12 have a sufficient structural strength and are not easily deformed.

With the specific shape of the screening holes 12, screened objects can rapidly pass through the screening holes 12 and can be kept from being stuck in the screening holes 12. The accuracy of screening objects can be improved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A filtering screen comprising:
a plate having
a top surface;
a bottom surface; and
at least one screening area defined in the plate and comprising multiple screening holes defined through the top surface and the bottom surface, and each screening hole having an upper segment and a lower segment connected and communicating with the upper segment, wherein
the upper segment of each screening hole has a unique diameter; and
the lower segment of each screening hole is conical and has a diameter gradually decreasing from a top end of the lower segment to a bottom end of the lower segment.

2. The filtering screen as claimed in claim 1, wherein the upper segment of each screening hole has a circular cross section; and
the lower segment of each screening hole has a circular cross section.

3. The filtering screen as claimed in claim 2, wherein the upper segment of each screening hole has a depth smaller than or equal to a depth of the lower segment of the screening hole.

4. The filtering screen as claimed in claim 1, wherein the upper segment of each screening hole has a depth smaller than or equal to a depth of the lower segment of the screening hole.
